(19) United States
(12) Patent Application Publication
(10) Pub. No.: US 2009/0194979 A1
(43) Pub. Date: Aug. 6, 2009

(54) Restraint System Comprising an Adjustable Outlet Cross Section

(75) Inventors: Werner Bacher, Sindelfingen (DE); Walter Eberle, Hochdorf (DE); Christian Goetz, Plochingen (DE); Simon Kramer, Schorndorf (DE); Martin Lanzerath, Denkendorf (DE); Manfred Linssen, Holzguenz (DE); Clark Ruedebusch, Holzgerlingen (DE); Matthias Struck, Stuttgart (DE); Alfred Wagner, Gomaringen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/994,370

(22) PCT Filed: Jun. 30, 2006
(86) PCT No.: PCT/EP06/06345

§ 371 Date: Aug. 5, 2008

(30) Foreign Application Priority Data
Jul. 2, 2005 (DE) 10 2005 030 991.7

(51) Int. Cl. B60R 21/215

(52) U.S. Cl. 280/728.3

(57) ABSTRACT

The invention relates to restraint system for a passenger of a vehicle who sits on a vehicle seat that can be placed in different positions. Said restraint system comprises an interior that is defined by a housing (1) and at least on gas bag, and at least one triggerable outlet (36-38) which is disposed on the housing (1) and can be closed by means of a closing element (3) that is movable from a closed position into an open position such that an internal pressure in the interior can be adjusted in accordance with passenger load-relevant parameters during an accident. In order to creat a restraint system that has a simple design and can be produced at a low cost, the restraint system further comprises an adjustable stop element (24) which limits the opening movement of the closing element (3) and is coupled to the vehicle seat in such a way that the stop element (24) is displaced according to passenger load-relevant parameters in order to adjust the cross section of the outlet that is defined by the closing element (30 located in the closed positions.

### BACKGROUND AND SUMMARY OF THE INVENTION

This invention relates to a restraint system for a passenger of a vehicle who is seated on a vehicle seat which may be placed in different positions. The system has an interior, which is defined by a housing, and at least one airbag, and includes at least one gas generator for delivering gas to the interior in order to inflate the airbag. Gas is able to be discharged from the interior via at least one controllable outlet provided on the housing, which may be closed by a closing element movable from a closed position into an open position, such that an internal pressure in the interior may be adjusted according to parameters relevant to passenger load during an accident.

A restraint system for a passenger of a vehicle is known from German published patent application DE 101 24 273 A1, having an interior which is defined by a housing and at least one airbag, and comprising at least one gas generator for delivering gas to the interior in order to inflate the airbag. For improving the safety of the passenger, gas may be discharged from the interior, via at least one controllable outlet, such that during an accident, an internal pressure is adjusted in the interior according to parameters relevant to passenger load. For controlling the outlet, at least one control device is provided with a closure member arranged on the outlet. An airbag module outlet comprising a ventilation member is known from German published patent application DE 10 2004 027 703 A1. the member may be moved between an open state, which allows the flow of inflation fluid through a ventilation opening, and a closed state, which blocks at least partially the flow of inflation fluid through the ventilation opening. A method for operating an airbag module is known from German published patent application DE 103 40 910 A1, in which a defined opening is actively adjusted by restricting the flow cross-section of an air intake aperture. A safety device comprising a housing wall is known from German published patent application DE 41 33 506 A1. In this device, an outlet is provided with an effective cross sectional area which may be altered. A protective device comprising a closed passage for the discharge of cooling gases from an airbag is known from German utility model DE 299 07 607 U1. The cross section of the passage is able to be fully or partially opened after activating the device. Gas generators with gas flows that may be regulated are known from European patent application EP 0 745 517 A1 and U.S. Pat. No. 5,366,242. Further restraint systems are known from German published patent application DE 100 20 795 A1 and German patent DE 197 49 780 C2. A safety device for motor vehicles is known from German published patent application DE 44 21 814 A1.

It is the object of the invention to provide a restraint system for a passenger of a vehicle that has a simple construction and that may be produced cost-effectively.

This object is achieved in a restraint system for a passenger of a vehicle who is seated on a vehicle seat which may be placed in different positions. The system has an interior which is defined by a housing and at least one airbag, and includes at least one gas generator for delivering gas to the interior in order to inflate the airbag. Gas is able to be discharged from the interior via at least one controllable outlet provided on the housing which may be closed by a closing element movable from a closed position into an open position. An internal pressure in the interior may be adjusted, according to parameters relevant to passenger load during an accident, by an adjustable stop element limiting the opening movement of the closing element, which is coupled to the vehicle seat such that the stop element is displaced according to the position of the vehicle seat, in order to adjust the outlet cross section which is defined by the closing element located in its closed position. As a result, the amount of gas flow escaping from the interior during an accident is easily adapted to the vehicle seat position in the longitudinal direction of the vehicle. The cross section of the outlet is automatically determined by the adjustable stop element according to the vehicle seat position.

In a preferred embodiment of the restraint system, the closing element is formed by a slide. The slide is preferably designed such that it closes a plurality of outlets simultaneously in its closed position, which it opens in its open position. Instead of the slide, a flap may also be used.

In a further preferred embodiment of the restraint system, the stop element is coupled to the vehicle seat by means of a Bowden cable, in particular a control cable. Preferably, a Bowden cable that is attached to a seat rail of the vehicle seat is used.

In a further preferred embodiment of the restraint system, the stop element is coupled to the vehicle seat by the interposition of a gear mechanism, in particular a step-down gearing. By means of the gear mechanism, for example, a vehicle seat adjusting path of 30 cm is converted into a stop element adjusting path of 2 cm.

According to further preferred embodiments of the restraint system, the stop element is coupled to the vehicle seat such that the outlet cross section is associated with the vehicle seat position in a linear, non-linear or restricted linear manner.

In a further preferred embodiment of the restraint system, the outlet cross section is opened in stages depending on the vehicle seat position and parameters relevant to passenger load.

In a further preferred embodiment of the restraint system, a second stop element defining the opening movement of the closing element cooperates with a seatbelt buckle switch in order to adjust the outlet cross section, which is defined by the closing element located in its closed position. Preferably, the second stop element is given precedence, independently of the first stop element and/or said outlet cross section. It is possible to monitor via the seatbelt buckle switch whether the passenger is wearing a seat belt. If the passenger is not wearing a seat belt, the airbag has to be firmer as it then represents the only restraint means. For example, a second stop for the closing element may be defined by means of a magnet which ensures that the closing element does not open at all or only opens slightly.

In a further preferred embodiment of the restraint system, the second stop element comprises a magnet. By means of the magnet, the duration of the closing element in the region of the stop may be prolonged.

In a further preferred embodiment of the restraint system, the closing element is moved from its closed position into its open position, by means of a pyrotechnic device, when the restraint system is activated. The pyrotechnic device is triggered according to the severity of the accident, the weight of the passenger and the seat belt status, amongst others. For these reasons, a defined switching time is calculated, i.e. a time period during which the pyrotechnic device is activated and the closing element is moved.

Further advantages, features and details of the invention are revealed from the following description, in which various embodiments are described in detail by referring to the drawings. In this case, the features mentioned in the claims and in the description may be essential to the invention, respectively individually per se or in any combination.

### BRIEF DESCRIPTION OF THE DRAWINGS

FIG. 1 shows a perspective view of a detail of a restraint system according to the invention with the outlets closed;

FIG. 2 shows the restraint system of FIG. 1 with the outlets open; and

FIG. 3 shows a Cartesian coordinate system in which the size of the outlet is plotted over the longitudinal position of a vehicle seat.

### DETAILED DESCRIPTION OF THE INVENTION

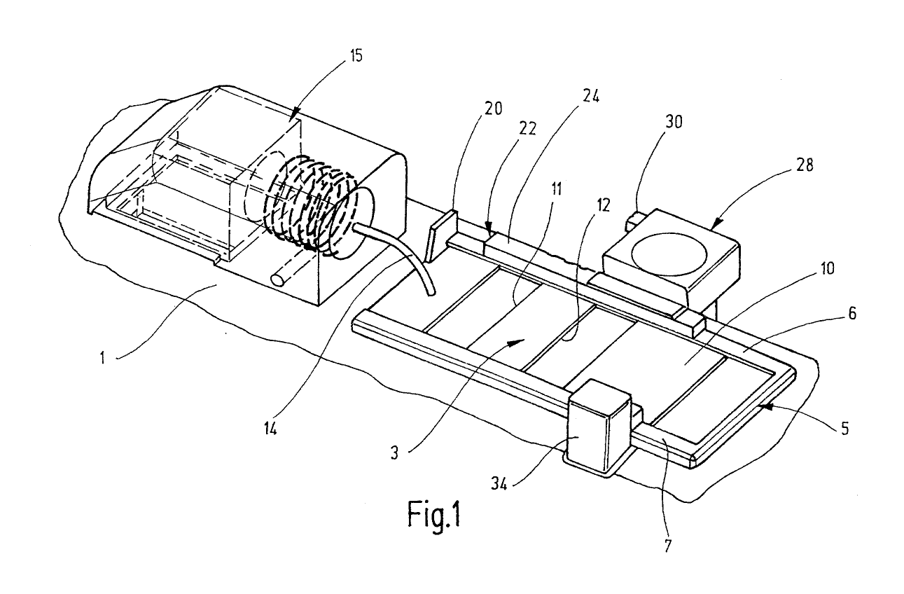

In FIG. 1, a detail of a restraint system according to the invention is shown in perspective. The system comprises a housing 1 with a slide 3. A U-shaped frame 5 is fastened to the housing 1, which has two guide rails 6, 7 arranged parallel to one another and in which the slide 3 is displaceably guided in the longitudinal direction of the guide rails 6, 7.

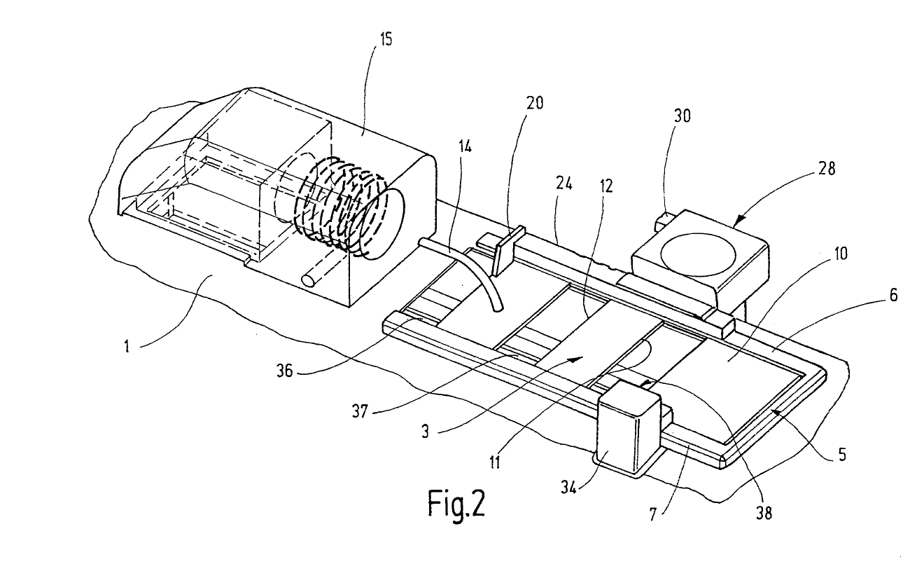

The slide 3 has the form of a rectangular plate 10 which has two rectangular openings 11, 12. In the region of one end of the slide 3, a curved actuating finger 14 extends from the rectangular plate 10. The free end of the actuating finger 14 is oriented toward a piston housing 15. In the piston housing 15 a pyrotechnic device is received, by means of which the slide 3 is moved via the actuating finger 14 from its closed position shown in FIG. 1 into its open position shown in FIG. 2.

Moreover, a stop lug 20 which projects at right angles from the rectangular plate 10 is fastened to the end facing the piston housing 15 of the rectangular plate 10 of the slide 3. The stop lug 20 is arranged in the closed position of the slide 3 at a distance from a stop surface 22 which is provided at one end of a stop rail 24. The stop rail 24 may be moved by means of a step-down gearing 28 relative to the housing and the U-shaped frame 5. The step-down gearing 28 has a receiver 30 for one end of a Bowden cable (not shown), the other end thereof being fastened to a vehicle seat.

In FIG. 2, the slide 3 is located in its open position. In the open position, the slide 3 opens three outlets 36 to 38, which are provided in the housing 1. In the open position of the slide 3, the stop lug 20 bears against the stop surface (22 in FIG. 1) of the stop rail 24. Thus the size of the opening cross section of the outlets 36 to 38 opened by the slide 3 is determined by the stop rail 24. The stop rail 24 is, in turn, moved by means of the step-down gearing 28 in the longitudinal direction of the guide rail 6 via the Bowden cable coupled to the vehicle seat, when the vehicle seat is adjusted. Thus the size of the outlets is adjusted by the longitudinal position of the seat. The Bowden cable is preferably attached to a seat rail and forms a direct connection for controlling the outlet cross section.

It may be additionally possible to monitor whether the passenger is wearing a seat belt via a seatbelt buckle switch 34. If the passenger is not wearing a seat belt, the airbag has to be firmer as it is used as the only restraint means. To this end, for example, a second stop for the slide may be defined by using a magnet, which ensures that the slide does not open at all or only opens slightly. Moreover, a new cross section is defined which should always be effective when the passenger is not wearing a seat belt. To this end, a magnet may be used which prolongs the duration of the slide in the region of the stop.

According to an essential aspect of the present invention, the longitudinal position of the seat determines the size of the outlet cross section in the opened state of the slide. When the passenger, for example a small person, adopts a seating position toward the front, the stop element is displaced such that the slide opens as much area of the opening cross section as possible. When the passenger, for example a large person, adopts a seating position toward the rear, the stop element, in particular the stop rail, is displaced such that the slide covers as much area of the opening cross section as possible. As a result, it is ensured that with a small person the airbag is soft and with a large person the airbag is as firm as possible. According to the vehicle conditions, a linear or non-linear control of the outlet cross section is possible depending on the longitudinal position of the seat.

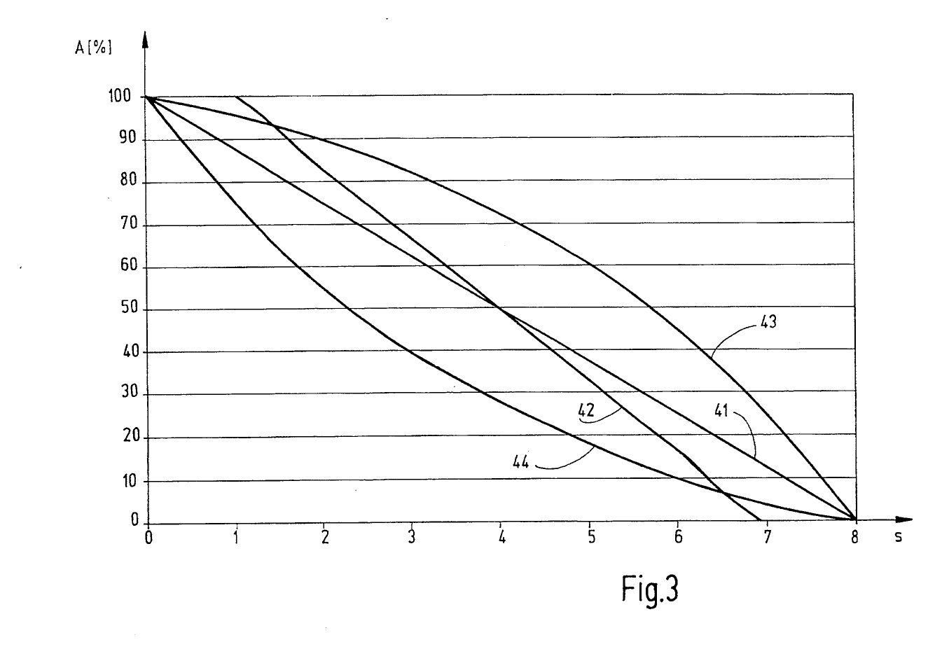

In FIG. 3, a Cartesian coordinate diagram is shown in which the outlet cross section A is plotted as a percentage over the longitudinal position of the seat S. At zero, the vehicle seat is in its front position and at eight it is in its rear end position. A linear connection is denoted at 41 and a limited linear connection is denoted at 42 between the outlet cross section and the longitudinal position of the seat. Two non-linear connections between the outlet cross section A and the longitudinal position of the seat S are denoted at 43 and 44.

1-11. (canceled)

12. A restraint system for a passenger of a vehicle who is seated on a vehicle seat that may be placed in different positions, comprising:
an interior, defined by a housing and at least one airbag,
at least one gas generator for delivering gas to the interior in order to inflate the airbag,
at least one controllable outlet, permitting discharge of gas from the interior, provided on the housing,
a closing element, movable from a closed position into an open position, by which the controllable outlet may be closed such that an internal pressure in the interior is adjustable according to parameters relevant to passenger load during an accident, and
an adjustable stop element limiting opening movement of the closing element,
wherein the stop element is coupled to the vehicle seat such that the stop element is displaced according to the position of the vehicle seat in order to adjust the outlet cross section defined by the closing element located in its closed position.

13. The restraint system as claimed in claim 12, wherein the closing element is formed by a slide.

14. The restraint system as claimed in claim 12, wherein the stop element is coupled to the vehicle seat by a Bowden cable.

15. The restraint system as claimed in claim 12, wherein the stop element is coupled to the vehicle seat by interposition of a gear mechanism.

16. The restraint system as claimed in claim 12, wherein the stop element is coupled to the vehicle seat such that the outlet cross section is associated with the vehicle seat position in a linear manner.

17. The restraint system as claimed in claim 12, wherein the stop element is coupled to the vehicle seat such that the outlet cross section is associated with the vehicle seat position in a non-linear manner.

18. The restraint system as claimed in claim 12, wherein the stop element is coupled to the vehicle seat such that the outlet cross section is associated with the vehicle seat position in a restricted linear manner.

19. The restraint system as claimed in claim 12, wherein the stop element is coupled to the vehicle seat such that the outlet cross section is opened in stages depending on the vehicle seat position and parameters relevant to passenger load.

20. The restraint system as claimed in claim 12, wherein a second stop element defining the opening movement of the closing element cooperates with a seatbelt buckle switch to adjust the outlet cross section, which is defined by the closing element located in its closed position.

21. The restraint system as claimed in claim 20, wherein the second stop element comprises a magnet.

22. The restraint system as claimed in claim 12, wherein the closing element is moved from its closed position into its open position, by a pyrotechnic device, when the restraint system is activated.

23. The restraint system as claimed in claim 14, wherein the Bowden cable is a control cable.

24. The restraint system as claimed in claim 15, wherein the gear mechanism defines step-down gearing.

25. The restraint system as claimed in claim 13, wherein the stop element is coupled to the vehicle seat by a Bowden cable.

26. The restraint system as claimed in claim 25, wherein the Bowden cable is a control cable.

27. The restraint system as claimed in claim 13, wherein the stop element is coupled to the vehicle seat such that the outlet cross section is associated with the vehicle seat position in a linear manner.

28. The restraint system as claimed in claim 13, wherein the stop element is coupled to the vehicle seat such that the outlet cross section is associated with the vehicle seat position in a non-linear manner.

29. The restraint system as claimed in claim 13, wherein the stop element is coupled to the vehicle seat such that the outlet cross section is associated with the vehicle seat position in a restricted linear manner.

30. The restraint system as claimed in claim 13, wherein the stop element is coupled to the vehicle seat such that the outlet cross section is opened in stages depending on the vehicle seat position and parameters relevant to passenger load.

31. The restraint system as claimed in claim 13, wherein a second stop element defining the opening movement of the closing element cooperates with a seatbelt buckle switch to adjust the outlet cross section, which is defined by the closing element located in its closed position.
